(19) United States
(12) Patent Application Publication
(10) Pub. No.: US 2024/0051736 A1
(43) Pub. Date: Feb. 15, 2024

(54) INLET VALVE FOR AN INFUSION CONTAINER, AND INFUSION CONTAINER

(71) Applicant: SWISS TEA INNOVATION AG, Olten (CH)

(72) Inventors: Joseph Alain SCHERRER, Wangen b. Olten (CH); Franco DEL BON, Aarburg (CH); Theodor WÜST, Wetzikon (CH)

(73) Assignee: SWISS TEA INNOVATION AG, Olten (CH)

(21) Appl. No.: 18/044,674

(22) PCT Filed: Sep. 2, 2021
(86) PCT No.: PCT/EP2021/074277

§ 371 Date: Mar. 9, 2023

(30) Foreign Application Priority Data
Sep. 10, 2020 (CH) 01136/20

(51) Int. Cl. B65D 85/804; B65D 21/08; A47J 31/46; A47J 31/06; A47J 31/18

(52) U.S. Cl. CPC B65D 85/8049; B65D 85/8061; B65D 85/8052; B65D 21/086; A47J 31/461; A47J 31/0615; A47J 31/18

(57) ABSTRACT

An inlet valve (10) for an infusion container (20) to receive a dried infusion substance, and to an infusion container (20). The inlet valve (10) includes a closure cap (11) and a valve body (12). The closure cap (11) and the valve body (12) are connected to one another in a separable manner via a thinned material location (13).

The present invention relates to an inlet valve for an infusion container as well as an infusion container comprising an inlet valve according to the preamble of the independent claims.

An infusion beverage is understood in connection with the present invention as any type of beverage that can be prepared, starting from a dried infusion substance, by contact with a cold or hot infusion liquid. A typical infusion beverage is tea, for example, that is prepared by brewing tea leaves or herbs with hot water.

It is known that different types of teas require a comparatively long brewing of several minutes duration to optimally develop their aroma. The contact time between the tea leaves and the brewing water must therefore be sufficiently long.

Known from EP 3 119 245 B1 is a tea preparation device and a method which allows a measured amount of a dried infusion substance to be brought in contact with an infusion liquid over a certain contact time. This is made possible by an expandable infusion container. In order to bring the infusion liquid into the container, a lid of this container is pierced with a filling needle and the infusion liquid is introduced into the container through this filling needle.

This process is associated with no inconsiderable expenditure of force. The filling needle can become blunt, which increases the expenditure of force for piercing and can thus lead to an incorrect manipulation. The need for a hollow needle as filling needle limits the flow into the infusion container.

It is the object of the invention to eliminate at least one or more disadvantages of the prior art. In particular, an inlet valve should be provided for an infusion container that enables a secure, simple and in particular reproducible operation and preferably can provide a sufficiently large opening for introducing the infusion liquid into the infusion container.

This object is achieved by the devices defined in the independent claims. Further embodiments are obtained from the dependent claims.

An inlet valve according to the invention for an infusion container for receiving a dried infusion substance comprises a valve cap and a valve body. The valve cap and the valve body are connected to one another in a separable manner via a material thin point.

The connection of the closure cap to the valve body via a material thin point enables these two elements to be separated from one another with little expenditure of force and to provide a filling opening along the broken-open material thin point through which the infusion liquid can be introduced into the infusion container.

The closure cap additionally makes it possible to guide and/or hold this on a corresponding counter-piece such as a support, for example.

It can be provided that the closure cap comprises a base body and a wall extending therefrom, which runs around along the base body.

The circumferential wall enables a uniform, in particular position-independent guidance of the closure cap on a corresponding counter-piece. As a result of the formation of a base body, a defined stop can be created which limits any movement of the closure cap in the direction of the wall.

The wall can therefore in particular be configured to be hollow-cylindrical and have a first end and a second end. The first end adjoins the base body and the second end adjoins the material thin point.

This allows simple, cheap and in particular reproducible manufacture.

Preferably the material thin point is configured to be circumferential around the closure cap.

The closure cap can thus be separated completely from the valve body which enables a subsequent relative movement between the valve body and the closure cap.

The material thin point can be configured as a tear-off film. A tear-off film is a point in the material having a small height or thickness in relation to the width. A tear-off film is typically thicker than 10 μm and preferably does not exceed a thickness of 500 μm. It is in particular at most half as thick as an adjoining wall.

The valve body can have a valve base extending radially towards a centre of the inlet valve, which adjoins the material thin point.

The valve body is therefore spaced apart from the material thin point via this valve base. The material thin point is therefore accessible.

A wall extending from the valve base, which runs around along the valve base can be arranged on the valve base to form a step. This wall is therefore part of the valve body.

The circumferential wall makes it possible to receive a corresponding counter-piece in the valve body, such as for example a filling nozzle and guide this along the valve base. As a result of the circumferential arrangement of the wall, a corresponding filling nozzle can be guided, in particular independent of position. In addition, it is possible to easily provide a circumferential seal between this wall and a corresponding filling nozzle.

This can be configured to be hollow-cylindrical and can have a first end and a second end. The first end adjoins the valve body base and the second end adjoins a base body extending radially outwards therefrom.

This allows a simple, cost-effective and in particular reproducible manufacture.

Preferably the wall of the valve body and the wall of the closure cap are arranged substantially concentrically with respect to one another.

In this case, the walls extend substantially over the same length.

The wall of the valve body and the wall of the closure cap can jointly with the valve body base have a substantially U-shaped cross-sectional profile. The material thin point is accordingly arranged at the base of the U-shaped profile.

Such a configuration makes it possible to arrange a corresponding inlet valve in a lid part of an infusion container in such a manner that this is recessed inside the lid part and does not protrude over the lid part.

The walls can also run towards one another in the direction of the material thin point, i.e. can be configured conically. In this case, each wall can have a slope of up to 5°.

This on the one hand facilitates manufacture, on the other hand, as a result of such a conical configuration a reliable connection can be made between the walls and a corresponding counter-piece such as a support or a filling nozzle, for example.

In particular, the base body of the closure cap is arranged substantially in the same plane as a base body of the valve body and preferably offset in a direction towards the interior of the infusion container.

The base body can in particular be configured as an integral part of a lid part of an infusion container.

One or more support elements can be formed on the base body and/or on the valve base.

As a result, a defined distance can be created and/or a movement of a corresponding element can be restricted.

These support elements can each cooperate with corresponding counter-pieces on the infusion container, in particular on a base part of the infusion container.

The inlet valve, in particular the closure cap and/or the valve body can be fabricated in an injection moulding process from plastic, in particular from a biologically degradable plastic, preferably from a bio-based plastic.

A further aspect of the invention relates to an infusion container for receiving a dried infusion substance for the preparation of an infusion beverage. The infusion container comprises a base part, a lid part and a wall part connecting the base part and the lid part and an inlet valve as described previously. The inlet valve is formed in the lid part.

This enables simple and integral manufacture of at least the lid part of the infusion container. An additional working step for attachment of a corresponding valve is superfluous.

The infusion container is preferably expandable, wherein in particular the wall part has a variable length.

On the one hand, this enables a dried infusion substance located in the infusion container to swell up, on the other hand the infusion container can be transported and stored before use with little space requirement.

With the exception of the presently described inlet valve, the infusion container can in particular be configured according to the infusion container which is described and claimed in EP 3 119 245 B1. The infusion container is therefore in particular configured for receiving an infusion liquid in a fluid-tight manner and configured to be expanded from a collapsed shape into an expanded shape by introducing infusion liquid. Said container is fitted with an outlet valve which preferably opens when an excess pressure is exceeded in the infusion container. This outlet valve is arranged in the bottom part. However, the outlet valve can also be configured as a mechanically openable valve.

The presently described infusion container is in particular suitable for carrying out the method which is described and claimed in EP 3 119 245 B1. The method in particular comprises a method in which a measured amount of a dried infusion substance is brought in contact with a measured amount of an infusion liquid and the infusion beverage is thereby produced. The dried infusion substance is provided in the infusion container which is initially present in a collapsed form and is expandable into an expanded form. The infusion liquid is introduced into the infusion container. The infusion container is expanded so that the dried infusion substance in the infusion container is brought in contact with the infusion liquid for a contact time to form the infusion beverage. The infusion container is then returned at least partially into its collapsed state by compressing and in so doing the infusion beverage is expelled at least partially from the infusion container.

A support for abutment of the closure cap can be arranged on the base part of the infusion container.

By means of such a support the closure cap can be held in a specific position relative to the base part. In addition, such a support enables forces acting on the closure cap, for example, to be absorbed via the base part.

A guidance of the closure cap can also be provided by such a support.

In particular, it can be provided in this case that the support cooperates with a corresponding wall of the valve cap of the inlet valve. For this purpose, the support can for example have a substantially cylindrical wall which cooperates with a correspondingly hollow-cylindrical wall of the closure cap as presently described.

Both walls can be configured complementarily and slightly conically so that any movement of the walls towards one another results in jamming of these walls.

The support can additionally be configured in such a manner that this restricts any movement of the closure cap.

The support can be arranged on a dispensing opening of the infusion container and can be configured at least in some areas as a filter sieve.

This configuration on the one hand prevents the dried infusion substance being dispensed together with the infusion beverage from the infusion container and on the other hand, as a result of the corresponding configuration as a support, a double function can be provided where the support can in this case in particular provide the presently described guidance and limitation of the movement of the closure cap. In addition, such a configuration enables the infusion container to be held in a simple manner in the collapsed form.

The support can therefore have a guide element for guiding the closure cap.

Preferably the valve body adjoins the wall part, wherein in particular the base body of the valve body adjoins the wall part.

As a result of this configuration, a lid part is provided which contains the inlet valve. In other words, the inlet valve is formed in one piece and provides the lid part.

This allows simple and cost-effective manufacture and enables further elements and/or components to be dispensed with.

The invention is explained in detail hereinafter with reference to an exemplary embodiment by reference to schematic figures. In the figures:

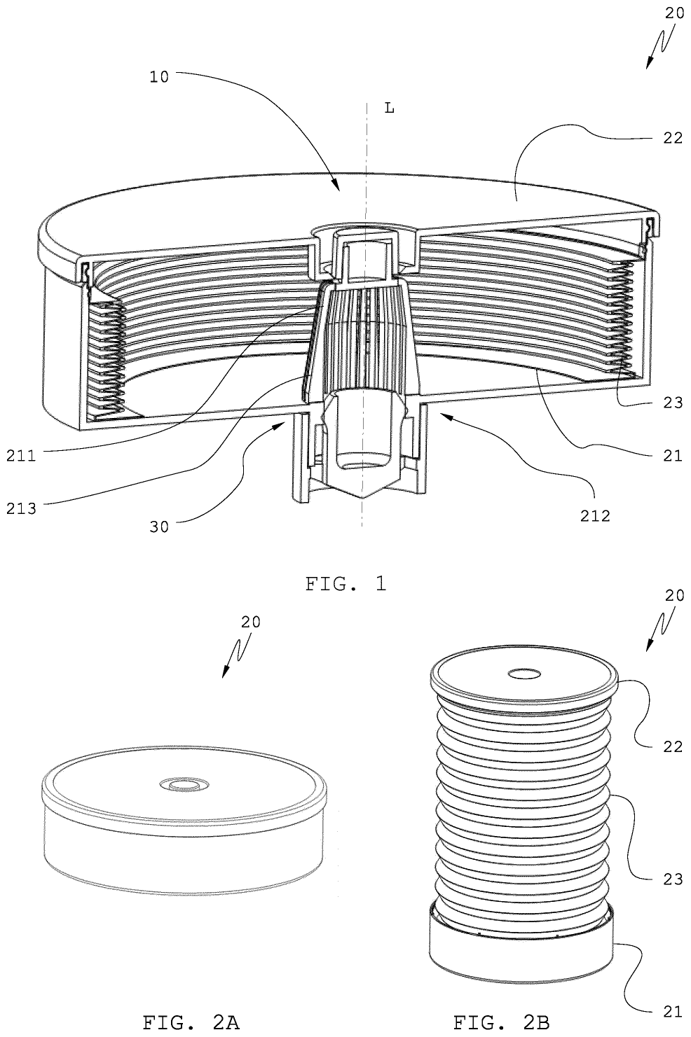

FIG. 1: shows a perspective sectional view of an infusion container;

FIG. 2A: shows a perspective view of the infusion container from FIG. 1 in a collapsed form;

FIG. 2B: shows a perspective view of the infusion container of FIG. 2A in an expanded form;

FIG. 3: shows a detailed view of the inlet valve from FIG. 1;

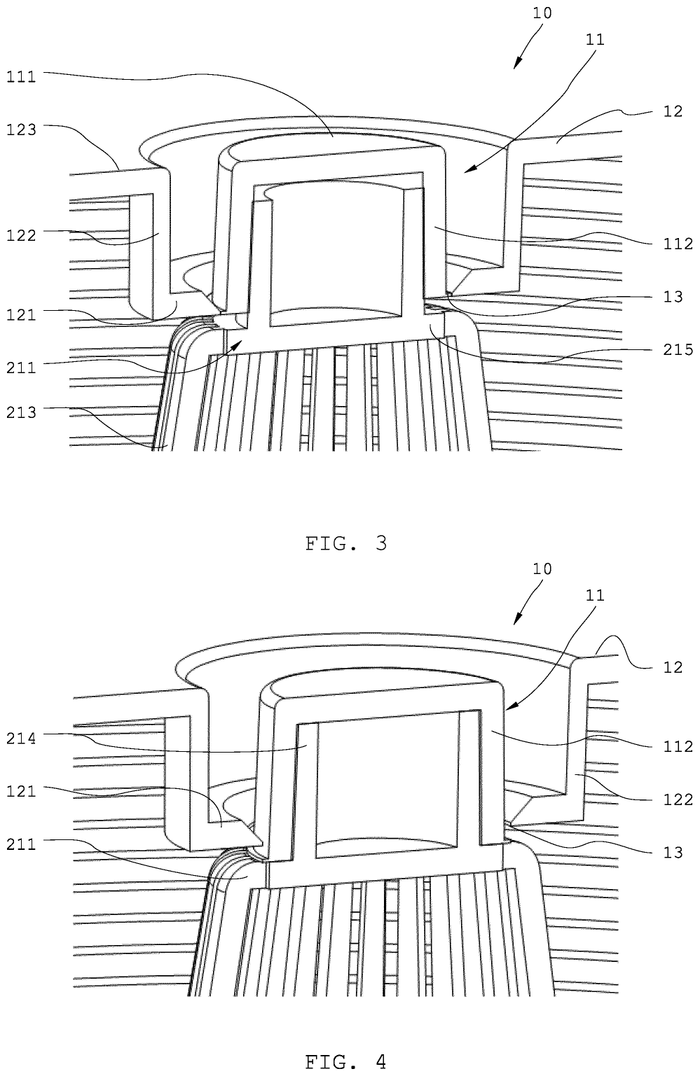

FIG. 4: shows a detailed view from FIG. 3 with broken-open inlet valve.

For the sake of better clarity in all the figures the dried infusion substance optionally located in the infusion container 20 is not shown.

FIG. 1 shows a perspective sectional view of an infusion container 20. The infusion container 20 has an inlet valve 10 and an outlet valve 30 with a dispensing opening 212. The infusion container itself comprises a base part 21, a lid part 22 and a wall part 23. The wall part 23 is expandable and in the present case is configured in the form of a bellows and fabricated from a flexible plastic. The wall part 23 is on the one hand connected in a liquid-tight manner to the base part 21 and on the other hand is connected in a liquid-tight manner to the lid part 22. This wall part 23 is enclosed by the base part 21 and by the lid part 22. To this end, a wall extending in the direction of the lid part 22 is provided on the base part 21 on the periphery thereof. As can be seen in FIG. 1, the inlet valve 10 is configured as an integral component of the lid part 22.

The inlet valve 10 is arranged on a support 211 and therefore accordingly spaced apart from the base part 21. In the present case, the support is configured as an integral component of the base part 21.

The infusion container 20 according to FIG. 1 is configured to be substantially rotationally symmetrical and has a central axis L. This also defines an axial direction. A central axis is also provided in non-rotationally symmetrical configurations of the infusion container 20. This is substantially defined by the connection of inlet valve 10 and outlet valve 30. A flow direction which runs from the inlet valve 10 to the outlet valve 30 is also defined by the inlet valve 10 and the outlet valve 30.

FIG. 2A shows a perspective view of the infusion container 20 from FIG. 1 in a collapsed form. As can be seen from FIG. 2A and from FIG. 1, in the collapsed form the base part 21 is connected to the lid part 22 via the wall arranged on the periphery thereof with corresponding break-open elements.

FIG. 2B shows a perspective view of the infusion container from FIG. 2A in an expanded form. By introducing an excess pressure via the inlet valve 10 (see FIG. 1), the break-open elements of the wall of the base part 21 are broken open and the wall part 23 expands as a result of the filling of infusion liquid into the infusion container 20. It is understood that before introducing the excess pressure, the material thin points 13 of the inlet valve 10 have been broken open, as will be explained hereinafter with reference to FIGS. 3 and 4. The infusion container 20 subsequently remains in this expanded form for a predetermined time and is then compressed to expel the infusion beverage. As a result of the compression or an additional device, the outlet valve 30 (see on this matter FIG. 1) is opened and the infusion beverage is dispensed through this outlet valve 30.

FIG. 3 shows a detailed view of the inlet valve 10 from FIG. 1 in a sectional view according to FIG. 1. The inlet valve 10 has a closure cap 11 and a valve body 12. The closure cap 11 has a base body 111 and a wall 112 extending from this base body 111. The wall 112 extends in the direction of the interior of the infusion container 20 and in the present case in the direction of the base part 21 in which the outlet valve 30 (see on this matter FIG. 1) is arranged. The wall 112 is configured as a hollow-cylindrical wall wherein a first end of the wall 112 adjoins the base body 111 and a second end of the wall 112 adjoins a material thin point 13. The material thin point 13 is disposed between the closure cap 11 and the valve body 12. The material thin point 12 is configured to run around along the wall 112. Said material thin point adjoins a valve body base 121 extending radially from the centre of the inlet valve 10. The valve body base 121 is part of the valve body 12. The valve body 12 therefore comprises the valve body base 121 and a wall 122 running around along this valve body base 121. This wall 122 adjoins a base body 123. The base body 123 is configured in the present case as an integral component of the lid part 22 (see FIG. 1).

The base body 123 and the base body 111 lie substantially in one plane. The respective walls 122 and 123 extend from this plane in the direction of the outlet valve 30 and accordingly in the direction of the material thin point 13. The two walls 122 and 112 together with the valve body base 121 form a substantially U-shaped cross-section, wherein the material thin point 13 is formed at the base of this cross-section. The two legs of the U's, provided by the walls 122 and 112, are running slightly conically in the direction of the material thin point 13.

The closure cap 11 has a substantially hat-shaped configuration overall. The closure cap 11 is in operative connection with a support 211 and is guided on this in the axial direction. For this purpose this has a guide element 214 (see FIG. 4). As illustrated in FIG. 3, the end of the wall 112 which is adjoined by the material thin point 13, is axially spaced apart from a corresponding counter-piece of the support 211. The counter-piece on the support 211 is configured as a circumferential shoulder 215.

FIG. 3 shows overall a configuration in which the infusion container 20 is collapsed and the material thin point 13 is not yet broken open, in other words this corresponds to a delivery state.

FIG. 4 shows the detailed view from FIG. 3 with broken-open inlet valve 10 or with broken-open material thin point 13. In order to break open the material thin point 13, the closure cap 11 is pressed in the direction of the support 211 until a lower end of the wall 112 of the closure cap 11 rests against the circumferential shoulder 215 of the support 211. As a result of this relative movement of the closure cap 11 towards the valve body 12, the material thin point 13 is broken open. A filling opening is formed along the material thin point 13.

The support 211 has a filter sieve 213 and is arranged in the flow direction upstream of the outlet valve 30 (see on this matter FIG. 1). A guide element 214 is formed on the support 211 that is in operative connection with the wall 112 and provides an axial guide for the wall 112. The valve body 12 whose base body 123 is formed as an integral component of the lid part 22 is supported on the circumferential wall of the base part 21 (see on this matter FIG. 1). A force acting in the valve body 12 is therefore absorbed in the base part 21. The valve body 12 can therefore hold its relative position in relation to the support 211. When a force acts on the closure cap 11 and as a result of the displacement of the closure cap 11 in the axial direction, shear forces are formed in the material thin point 13 which break this open.

It can, for example, additionally be provided to provide further elements in the region of the shoulder 215 of the support 211 radially outside the material thin point 13 which, for example can support the valve base 121. Alternatively it can also be provided to provide support elements on the valve base 121 which in particular cooperate with the shoulder 215 and support the valve base 121 on the shoulder 215.

1-15. (canceled)

16. An inlet valve (10) for an infusion container (20) for receiving a dried infusion substance, the inlet valve (10) comprises a closure cap (11) and a valve body (12), wherein the closure cap (11) and the valve body (12) are connected to one another in a separable manner via a material thin point (13).

17. The inlet valve (10) according to claim 16, wherein the closure cap (11) comprises a base body (111) and a wall (112) extending therefrom, which runs around along the base body (111).

18. The inlet valve (10) according to claim 17, wherein the wall (112) is configured to be hollow-cylindrical and has a first end and a second end, wherein the first end adjoins the base body (111) and the second end adjoins the material thin point (13).

19. The inlet valve (10) according to claim 16, wherein the material thin point (13) is configured to be circumferential around the closure cap (11).

20. The inlet valve (10) according to claim 16, wherein the material thin point (13) is configured as a tear-off film.

21. The inlet valve (10) according to claim 16, wherein the valve body (12) has a valve base (121) extending radially towards a center, which adjoins the material thin point (13).

22. The inlet valve (10) according to claim 21, wherein a wall (122) extending therefrom, which runs around along the valve base (121) is arranged on the valve base (121) to form a step.

23. The inlet valve (10) according to claim 22, wherein the wall (122) is configured to be hollow-cylindrical and has a first end and a second end, wherein the first end adjoins the valve base (121) and the second end adjoins a base body (123) extending radially outwards therefrom.

24. The inlet valve (10) according to claim 23, wherein one or more support elements are formed on the base body (123) and/or on the valve base (121).

25. An infusion container (20) for receiving a dried infusion substance for the preparation of an infusion beverage, comprising a base part (21), a lid part (22) and a wall part (23) connecting the base part (21) and the lid part (22) and an inlet valve (10) according to claim 16, wherein the inlet valve (10) is formed in the lid part (22).

26. The infusion container (20) according to claim 25, wherein the infusion container (20) is expandable, wherein in particular the wall part (23) has a variable length.

27. The infusion container (20) according to claim 25, wherein a support (211) for abutment of the closure cap (11) is arranged on the base part (21).

28. The infusion container (20) according to claim 25, wherein the support (211) is arranged on a dispensing opening (212) and is configured at least in some areas as a filter sieve (213).

29. The infusion container (20) according to claim 27, wherein the support (211) comprises a guide element (214) for guiding the closure cap (11).

30. The infusion container (20) according to claim 25, wherein the valve body (12) adjoins the wall part (23), in particular that the base body (123) adjoins the wall part (23).
